(19) United States
(12) Patent Application Publication
(10) Pub. No.: US 2018/0037487 A1
(43) Pub. Date: Feb. 8, 2018

(54) CONTINUOUS GLASS PROCESSING APPARATUS AND METHOD OF PROCESSING FLEXIBLE GLASS RIBBON

(71) Applicant: CORNING INCORPORATED, CORNING, NY (US)

(72) Inventors: Kurt Edward Gerber, Dansville, NY (US); Uta-Barbara Goers, Campbell, NY (US); Nikolay Anatolyevich Panin, Painted Post, NY (US); James Ernest Webb, Corning, NY (US)

(21) Appl. No.: 15/555,306

(22) PCT Filed: Mar. 2, 2016
(86) PCT No.: PCT/US2016/020342

§ 371 Date: Sep. 1, 2017

Related U.S. Application Data
(60) Provisional application No. 62/127,524, filed on Mar. 3, 2015.

(51) Int. Cl. C03B 13/16

(52) U.S. Cl. CPC C03B 13/16; B65H 23/32

(57) ABSTRACT

A method of selecting a radius of curvature for a conveying structure (22) of a continuous glass processing apparatus for processing a flexible glass ribbon (20) having a thickness of no more than about 0.3 mm is provided. The method includes identifying a thickness of the flexible glass ribbon (20). A predetermined bending stress level is selected that is suitable for the flexible glass ribbon (20) during the processing of the flexible glass ribbon. A radius (R) of curvature is selected for a conveying structure that is suitable for conveying the flexible glass ribbon (20) during the processing of the flexible glass ribbon through the glass processing apparatus based on the predetermined bending stress and at least one of web deflection angle and line tension. The glass processing apparatus is provided including the conveying structure.

This application claims the benefit of priority to U.S. Application No. 62/127,524 filed on Mar. 3, 2015 the content of which is incorporated herein by reference in its entirety.

### TECHNICAL FIELD

The present invention relates to apparatus and methods for processing of flexible glass ribbon and, in particular, methods utilizing flexible glass ribbon stiffness to manage bending stress over conveying structures.

### BACKGROUND

Thin glass substrates can be used in a variety of applications including, for example, consumer or commercial electronics, consumer or commercial appliance, architectural, or building material applications. The glass for such substrates can be quite thin such as, for example, less than about 0.3 mm. Such substrates can be processed by conveying the substrate as a long, flexible glass ribbon (e.g., in a roll-to-roll process).

It is commonly believed that larger diameter rollers are needed for glass processing apparatus in order to maintain bending stresses of the flexible glass ribbon below a predetermined stress level suitable for reliably processing the flexible glass ribbon. For example, one common design parameter for flexible glass ribbon is to use rollers having diameters of at least six inches or more for processing flexible glass ribbon of 200 μm thickness or thinner. The intent is to minimize bend stress produced in the flexible glass ribbon, thereby reducing risk for flaw growth and crack propagation due to fatigue.

### SUMMARY

The present concept involves methods utilizing flexible glass ribbon stiffness to manage bending stress over rolls or other surfaces having a radius of curvature. Factoring in parameters such as web deflection angle and line tension of the flexible glass ribbon about the radius of curvature can provide a more accurate and reliable prediction of the bend stress realized by the flexible glass ribbon and can allow for a wider selection of radius lengths than those predicted by beam theory.

According to a first aspect, a method of selecting a radius of curvature for a conveying structure of a continuous glass processing apparatus for processing a flexible glass ribbon having a thickness of no more than about 0.3 mm is provided. The method includes identifying a thickness of the flexible glass ribbon. A predetermined bending stress level is selected that is suitable for the flexible glass ribbon during the processing of the flexible glass ribbon. A radius of curvature is selected for a conveying structure suitable for conveying the flexible glass ribbon during the processing of the flexible glass ribbon through the glass processing apparatus based on the predetermined bending stress and at least one of web deflection angle and line tension. The glass processing apparatus is provided including the conveying structure.

According to a second aspect, there is provided the method of aspect 1, wherein the step of selecting the radius of curvature includes using a design guide having a table.

According to a third aspect, there is provided the method of aspect 2, wherein the table includes ribbon thickness information, line tension information, roller diameter information, web deflection information and bend stress information.

According to a fourth aspect, there is provided the method of aspect 3, wherein the table is displayed on a printed medium.

According to a fifth aspect, there is provided the method of aspect 3, wherein the table is saved in memory of a computer.

According to a sixth aspect, there is provided the method of any one of aspects 1-5, comprising selecting a radius of curvature for multiple conveying structures suitable for conveying the flexible glass ribbon during the processing of the flexible glass ribbon through the glass processing apparatus based on at least one of web deflection angle and line tension.

According to a seventh aspect, there is provided the method of aspect 6, wherein the multiple conveying structures are adjacent, the method further comprising determining a distance between the adjacent conveying structures.

According to an eighth aspect, there is provided the method of aspect 7, wherein if the distance between the adjacent conveying structures is less than a predetermined distance, the step of selecting the radius of curvature includes using a design guide having a table.

According to a ninth aspect, there is provided the apparatus of aspect 7, wherein if the distance between the adjacent conveying structures is more than a predetermined distance, the step of selecting the radius of curvature includes using a finite element analysis software tool.

According to a tenth aspect, a method of continuous processing flexible glass ribbon having a thickness of no more than 0.30 mm using a glass processing apparatus is provided. The method includes providing a glass processing apparatus including a conveying structure having a radius of curvature suitable for conveying the flexible glass ribbon during the processing of the flexible glass ribbon through the glass processing apparatus. The radius of curvature is selected based on a predetermined bending stress and at least one of a web deflection angle and a line tension of the flexible glass ribbon. The flexible glass ribbon is continuously fed about the conveying structure during processing of the flexible glass ribbon.

According to an eleventh aspect, there is provided the method of aspect 10, wherein the step of providing the glass processing apparatus includes selecting the radius of curvature for the conveying structure suitable for conveying the flexible glass ribbon during the processing of the flexible glass ribbon through the glass processing apparatus based on the predetermined bending stress and at least one of web deflection angle and line tension.

According to a twelfth aspect, there is provided the method of aspect 11, wherein the step of selecting the radius of curvature includes using a design guide having a table.

According to a thirteenth aspect, there is provided the method of aspect 12, wherein the table includes ribbon thickness information, line tension information, roller diameter information, web deflection information and bend stress information.

According to a fourteenth aspect, there is provided the method of aspect 13, wherein the table is displayed on a printed medium.

According to a fifteenth aspect, there is provided the method of aspect 13, wherein the table is saved in memory of a computer.

According to a sixteenth aspect, there is provided the method of any one of aspects 10-15, comprising selecting a radius of curvature for multiple conveying structures suitable for conveying the flexible glass ribbon during the processing of the flexible glass ribbon through the glass processing apparatus based on at least one of web deflection angle and line tension.

According to a seventeenth aspect, there is provided the method of aspect 16, wherein the multiple conveying structures are adjacent, the method further comprising determining a distance between the adjacent conveying structures.

According to an eighteenth aspect, there is provided the method of aspect 17, wherein if the distance between the adjacent conveying structures is less than a predetermined distance, the step of selecting the radius of curvature includes using a design guide having a table.

According to a nineteenth aspect, there is provided the method of aspect 17, wherein if the distance between the adjacent conveying structures is more than a predetermined distance, the step of selecting the radius of curvature includes using a finite element analysis software tool.

According to a twentieth aspect, there is provided the method of any one of aspects 11-19, comprising selecting the radius of curvature for the conveying structure suitable for conveying the flexible glass ribbon during the processing of the flexible glass ribbon through the glass processing apparatus based on the predetermined bending stress level and both of the web deflection angle and the line tension. The flexible glass ribbon is continuously fed about the conveying structure at both the web deflection angle and the line tension during processing of the flexible glass ribbon.

According to a twenty-first aspect, a method of continuous processing of a flexible glass ribbon having a thickness of no more than 0.3 mm is provided. The method includes continuously feeding the flexible glass ribbon about a conveying structure having a radius of curvature that is less than a minimum radius of curvature (R) calculated using formula (1):

R=Eh/(2σ) (1)

where σ is a predetermined bend stress, E is a Young's Modulus of the flexible glass ribbon and h is the thickness of the flexible glass ribbon.

According to a twenty-second aspect, there is provided the method of claim 21, further comprising applying at least the predetermined bend stress to the flexible glass ribbon using the conveying structure having less than the minimum radius of curvature.

According to a twenty-third aspect, there is provided the method of aspect 1 or aspect 2, further comprising applying a line tension to the flexible glass ribbon suitable for applying at least the predetermined bend stress to the flexible glass ribbon using the conveying structure having less than the minimum radius of curvature.

According to a twenty-fourth aspect, there is provided the method of any one of aspects 21-23, further comprising applying a web deflection angle to the flexible glass ribbon suitable for applying at least the predetermined bend stress to the flexible glass ribbon using the conveying structure having less than the minimum radius of curvature.

According to a twenty-fifth aspect, there is provided the method of any one of aspects 1-24, wherein the conveying structure is a roller or an air bar.

According to a twenty-sixth aspect, a continuous glass processing apparatus for processing a flexible glass ribbon having a thickness of no more than about 0.3 mm is provided. The apparatus includes a conveying structure having a radius of curvature that is less than a minimum radius of curvature (R) calculated using formula (1):

R=Eh/(2σ) (1)

where σ is a predetermined bend stress, E is a Young's Modulus of the flexible glass ribbon and h is the thickness of the flexible glass ribbon.

According to a twenty-seventh aspect, there is provided the apparatus of aspect 26, wherein the conveying structure is a roller or an air bar.

According to a twenty-eighth aspect, there is provided the apparatus of aspect 26 or 27, further comprising an unwind station configured to unwind the flexible glass ribbon from a supply roll and a spooling station configured to wind the flexible glass ribbon onto a wind-up roll.

According to a twenty-ninth aspect, there is provided the apparatus of any of aspects 26-28, further comprising a vacuum deposition station configured to apply a coating to the flexible glass ribbon.

Additional features and advantages will be set forth in the detailed description which follows, and in part will be readily apparent to those skilled in the art from the description or recognized by practicing the invention as exemplified in the written description and the appended drawings and as defined in the appended claims. It is to be understood that both the foregoing general description and the following detailed description are merely exemplary of the invention, and are intended to provide an overview or framework to understanding the nature and character of the invention as it is claimed.

The accompanying drawings are included to provide a further understanding of principles of the invention, and are incorporated in and constitute a part of this specification. The drawings illustrate one or more embodiment(s), and together with the description serve to explain, by way of example, principles and operation of the invention. It is to be understood that various features of the invention disclosed in this specification and in the drawings can be used in any and all combinations.

### BRIEF DESCRIPTION OF THE DRAWINGS

FIG. 1 illustrates a glass element in bending to illustrate an example of bend stress;

FIG. 2 is a schematic view of a flexible glass ribbon traveling around a roller thereby inducing a bend stress in the flexible glass ribbon;

FIG. 3 is an exemplary chart illustrating a percent of beam theory maximum stress versus web deflection angle for multiple line tensions;

FIG. 4 is a schematic view of a flexible glass ribbon traveling around multiple rollers;

FIG. 5 is an exemplary chart illustrating bend stress versus roller spacing for multiple web deflection angles;

FIG. 6 is a diagrammatic illustration of an embodiment of a flexible glass processing apparatus;

FIG. 7 is a diagrammatic illustration of another embodiment of a flexible glass processing apparatus;

FIG. 8 illustrates an exemplary model using the flexible glass processing apparatus of FIG. 7;

FIG. 9 illustrates an embodiment of a method of selecting a roller diameter;

FIG. 10 illustrates an embodiment of an exemplary design guide for selecting a roller diameter for a flexible glass processing apparatus; and

FIG. 11 illustrates another embodiment of an exemplary design guide for selecting a roller diameter for a flexible glass processing apparatus.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

Embodiments described herein generally relate to methods utilizing flexible glass ribbon stiffness to manage bending stress over a radius of curvature of conveying structures. The methods utilizing flexible glass ribbon stiffness can be used, for example, in designing roll-to-roll systems including rolls with relatively small diameters, which can generate and control bend stress levels to a fraction of the stress predicted by beam theory, which dictate the use of relatively large rolls during flexible glass processing. While use of rolls or rollers is described primarily herein, other conveying structures with a radius of curvature may be used, such as an air bar or bearing of an air conveyor. It should be noted that while a roller or other conveying structure may have a constant radius of curvature, conveying structures may have a changing radius of curvature.

The flexible glass ribbons described herein may have a thickness of about 0.3 mm or less including but not limited to thicknesses of, for example, about 0.01-0.05 mm, about 0.05-0.1 mm, about 0.1-0.15 mm, about 0.15-0.3 mm, 0.3, 0.275, 0.25, 0.225, 0.2, 0.19, 0.18, 0.17, 0.16, 0.15, 0.14, 0.13, 0.12, 0.11, 0.10, 0.09, 0.08 0.07, 0.06, 0.05, 0.04, 0.03, 0.02, or 0.01 mm. The flexible glass ribbons may be formed of glass, a glass ceramic, a ceramic material or composites thereof. A fusion process (e.g., downdraw process) that forms high quality flexible glass ribbons can be used in a variety of devices and one such application is flat panel displays. Glass ribbons produced in a fusion process can have surfaces with superior flatness and smoothness when compared to glass sheets produced by other methods. The fusion process is described in U.S. Pat. Nos. 3,338,696 and 3,682,609.

While glass is generally known as a brittle material, inflexible and prone to scratching, chipping and fracture, glass having a thin cross section can in fact be quite flexible. Glass in long thin sheets or ribbons can be wound and un-wound from rolls, much like paper or plastic film. Nonetheless, flexible glass ribbon has some stiffness and is less pliable than many paper or plastic films. Additionally, during processing, the flexible glass ribbon often does not achieve “wrap” around one or more processing rolls, air bars, spools, spindles, etc. between a glass source and a glass destination, particularly depending on the radius of the one or more rolls. As used herein, the term “wrap” refers to flexible glass ribbon bending around a roll having a diameter with conformance of the flexible glass ribbon to the circumference of the roll. In other words, the bend radius of the flexible glass ribbon is about the same as the radius of the roll about its circumference. Accordingly, methods are provided that realize ribbon (sometimes referred to as line) tension T and ribbon (sometimes referred to as web) deflection angle θ can be used to manage the stress levels produced during a bending event, up to and including a maximum stress value predicted by beam theory.

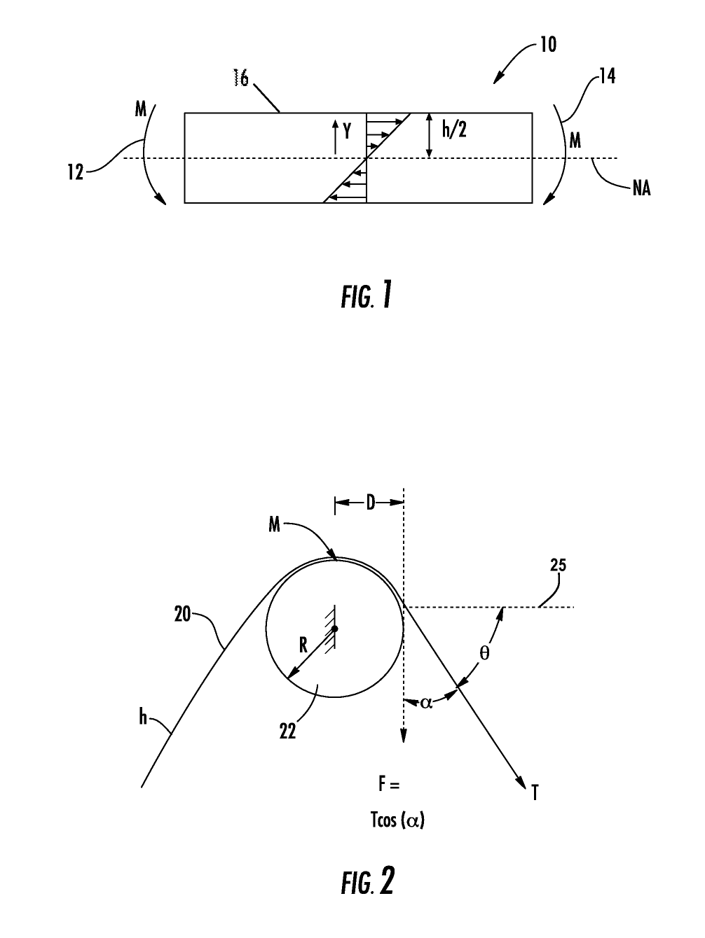

Referring to FIG. 1, a flexible glass element 10 is illustrated in bending, where a bending moment, represented by arrows 12 and 14 is applied at opposite ends of the flexible glass element 10. Such bending, as illustrated, generates tensile forces on one side of a neutral axis NA and compressive forces on the opposite side of the neutral axis NA. Because the maximum bend-induced tensile strength occurs at surface 16 (y=h/2), the maximum bend stress using beam theory may be given by:

σ=Eh/(2R) (1)

where, σ is bend stress, E is Young's Modulus, h is glass thickness and R is bend radius.

Without wishing to be bound by theory, it is believed that, despite being flexible, flexible glass stiffness inhibits wrapping of the flexible glass ribbon to levels defined by the maximum beam stress under certain tension and angular configurations of the flexible glass ribbon under processing conditions, resulting in lower bending stresses. Thus, it is believed that using the equation for maximum bend stress exclusively for determining radii of curvature of a particular flexible glass processing apparatus may result in utilization of unnecessarily large radii in an effort to reduce glass stress. Further, even where a predetermined level of glass stress is desired (e.g., approaching, including or exceeding the maximum bend stress), use of the maximum bend stress equation above may not be sufficient to reliably and consistently deliver that desired bend stress due to flexible glass stiffness. For example, a screening apparatus or screener may be used to ensure that the flexible glass has sufficient strength for an intended application. The flexible glass can be fed about a roller having a radius selected to produce the predetermined level of stress in the flexible glass. If the flexible glass survives being fed about the roller, the flexible glass has sufficient strength. If the roller is not properly sized to produce the predetermined level of stress, the flexible glass may survive being fed about the roller even if the flexible glass does not have sufficient strength. In other words, if the screener does not apply the predetermined stress to the flexible glass, the flexible glass that survives the screener may not have the desired strength.

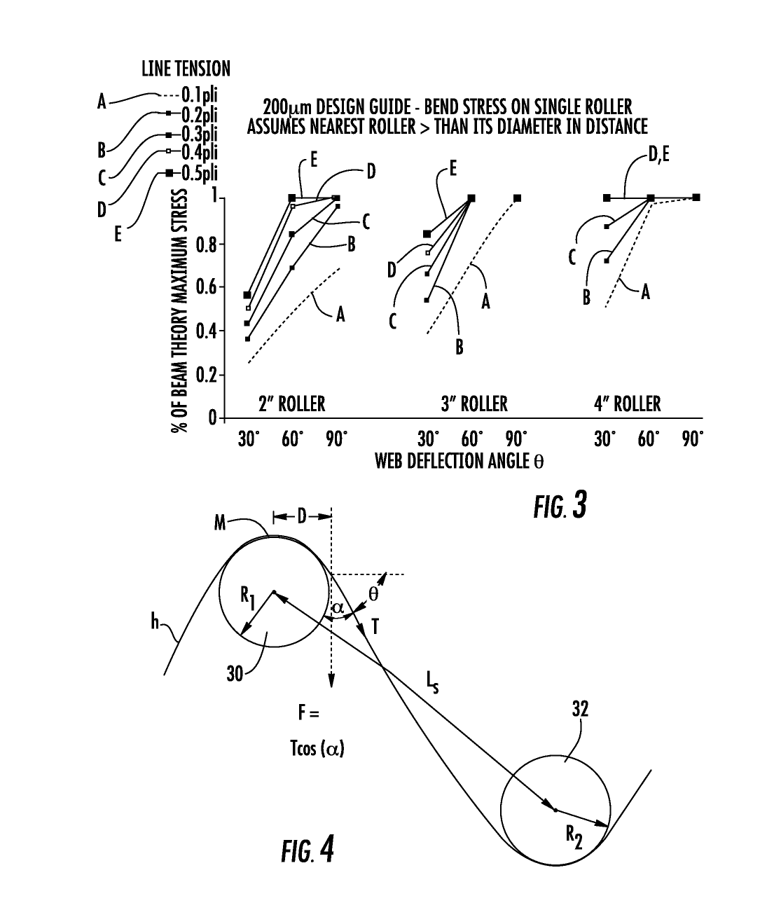

Referring to FIG. 2, a flexible glass ribbon 20 is illustrated bending over a roller 22 having a radius R. As can be seen, the flexible glass ribbon 20, while assuming some of the shape of the roller 22, has a stiffness that impedes wrapping of the flexible glass ribbon 20 less than a wrap angle α (measured from the perpendicular to the moment arm MA and tangent to the roller 22). As can be appreciated, as the wrap angle α decreases, the bend stress in the flexible glass ribbon 20 increases. Conversely, as the wrap angle α increases, the bend stress in the flexible glass ribbon 20 decreases. The following equations can be used to determine moment M of force F provided by a constant line tension T of the flexible glass ribbon 20 (assuming a frictionless roller and ignoring any drive rollers):

$$\begin{matrix}σ \sim \frac{1}{R} = \frac{M}{EI} & ( 2 ) \\ M = FD & ( 3 ) \\ F = T cos ( α ) & ( 4 ) \\ I = \frac{1}{12} ( {bh}^{ 3} ) & ( 5 )\end{matrix}$$

where, σ is bend stress, R is bend radius, M is moment of force, F is force, D is distance, T is web tension, E is Young's Modulus, I is moment of inertia, b is web width, h is glass thickness and α is wrap angle (FIG. 2). The moment M can be used in determining the bend stress for a particular roller diameter, which may be less than the maximum bend stress predicted by beam theory, as noted above.

Referring to FIG. 3, a single roller bend stress analysis of a 200 μm thick flexible glass ribbon determined for a different set of parameters (roller diameter, tension and ribbon deflection angle) using, for example, a finite element analysis (FEA) tool, such as commercially available from Autodesk, Inc. is illustrated. As used herein, “finite element analysis” refers to a computerized method for predicting how a product (e.g., a flexible glass ribbon) reacts to a variety of forces and under a variety of conditions. In the example of FIG. 3, FEA may be used to generate a design guide for a flexible glass processing apparatus that provides a predetermined percentage of the maximum bend stress predicted by beam theory for different roller diameters 2R, ribbon tensions T and ribbon deflection angles θ. As shown in FIG. 2, the ribbon deflection angle θ is measured from a line 25, the moment arm perpendicular from the force component F to the moment of force M. To illustrate, utilizing a two inch diameter roller and a ribbon deflection angle θ of about 60 degrees will result in about 85 percent of the maximum bend stress predicted by beam theory for a 200 μm thick flexible glass ribbon having a 0.3 pli (pounds per linear inch) ribbon tension T. Indeed, this 200 μm thick flexible glass ribbon having a 0.3 pli ribbon tension T will not reach the maximum bend stress predicted by beam theory using a two inch roller diameter until a ribbon deflection angle θ of at least 90 degrees is used. In contrast, a 200 μm thick flexible glass ribbon having a 0.3 pli ribbon tension T will reach the maximum bend stress predicted by beam theory using a three inch roller diameter at about a 60 degree ribbon deflection angle θ. However, the maximum bend stress predicted by beam theory for the three inch diameter roller is less than the maximum bend stress of the two inch diameter roller, given the increase in roller diameter and keeping other parameters the same.

The description of FIGS. 2 and 3 assumes use of a single roller or multiple rollers spaced apart a distance much greater (e.g., at least about 10 times more) than the diameter of roller 22 such that the roller of interest can be considered a single roller. When there are adjacent rollers in the path of the flexible glass ribbon of lesser spacing (e.g., no more than about 10 times the diameter), the roller-to-roller spacing Ls can play an important role in the analytical solution of the moment of force M. That is, when the spacing Ls is small, the bending of the flexible glass ribbon about one roller can interact with the bending of the flexible glass ribbon about the other roller.

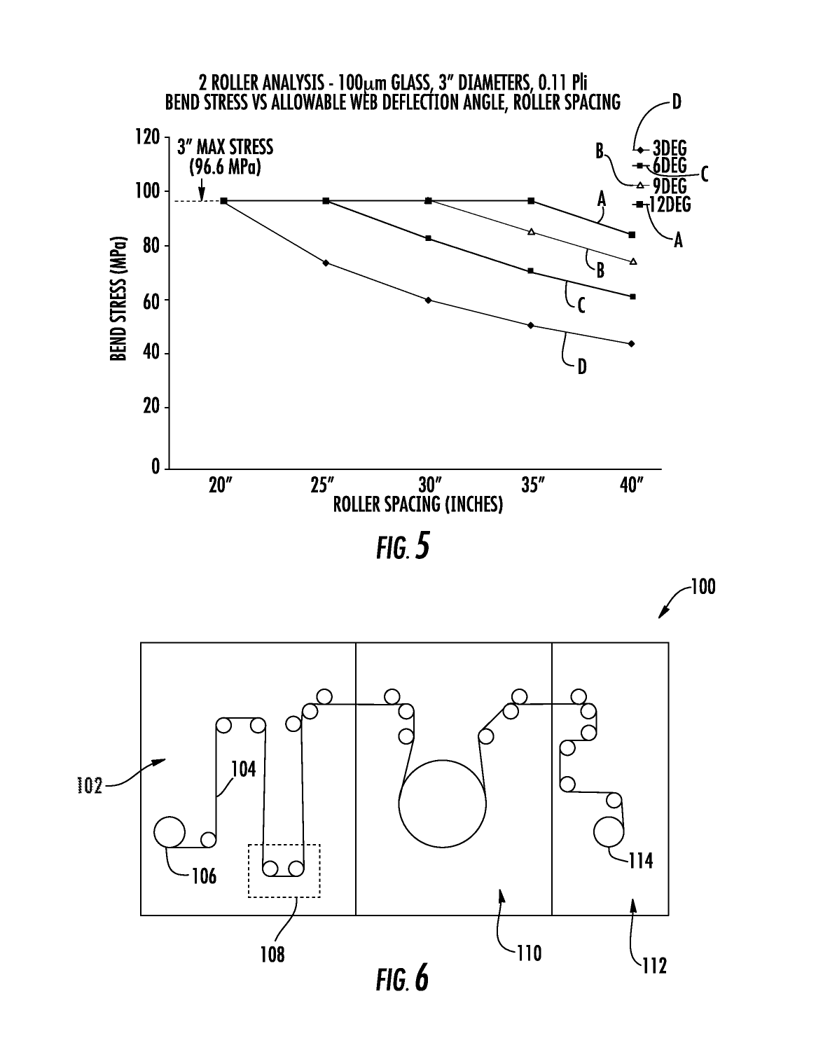

Referring to FIG. 4 as an example, the bend stress at roller 30 having a radius R₁ can be calculated as a single roller (FIG. 2) if the distance Ls between rollers 30 and 32 (center-to-center) is sufficiently large (e.g., 10 times 2R₁), assuming R₁ and R₂ are equal. However, when the spacing Ls is smaller, the resistance of the flexible glass web bending about the roller 32 can have an interaction effect on the flexible glass ribbon bending about the roller 30 resulting in the equation:

R=f(T,h,E,θ,Ls). (6)

As can be appreciated, the introduction of multiple rollers 30 and 32 can significantly increase the number of combinations of roller spacing Ls, line tension T and ribbon deflection angle θ for a given thickness h of the flexible glass substrate and roller diameter. An FEA model can allow for increased efficiency to enable effective trade-off decisions for a potential multiple roller design. FIG. 5 illustrates an example of a two roller analysis of 100 μm thick flexible glass ribbon, using three inch diameter rollers and a 0.11 pli line tension T. Using FIG. 5, the bend stress σ produced at a given roller is a function of the ribbon deflection angle θ, which is a function of roller spacing Ls. For example, at a roller spacing Ls of 40 inches and a web deflection angle θ of below 6 degrees, the bending stress σ produced will not exceed about 60 MPa. Additional graphs similar to FIG. 5 can be produced showing bend stresses σ for other line tension T values and allowable ribbon deflection angles θ.

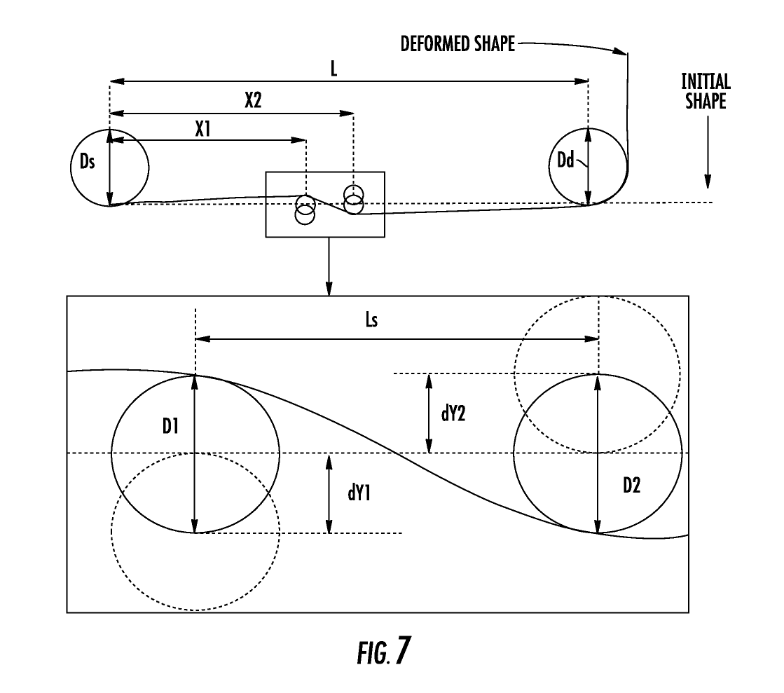

Referring briefly to FIG. 6, an exemplary flexible glass processing apparatus 100 may include multiple stations, such as an unwind and clean station 102 where a flexible glass ribbon 104 is unwound from a supply roll 106 and is cleaned at a cleaning station 108. The flexible glass ribbon 104 may then pass through a series of rollers to a vacuum deposition station 110 where any suitable coating may be applied to the flexible glass ribbon 104. The flexible glass ribbon 104 may then pass to a spooling station 112 where the flexible glass ribbon 104 is wound onto a wind-up roll 114. The guidelines and FEA techniques described herein may be applied to any one of the rollers of the flexible glass processing apparatus 100 on which the flexible glass ribbon 104 is conveyed.

### EXAMPLE

An analytical model was constructed and simulated using an FEA software tool. The analysis was used to determine the maximum theoretical bend stress capability of the model for any one of three roller diameters (3, 4 and 5 inches). The model layout, operating inputs and material parameters used in the modeling analysis are shown in Tables I and II below and FIG. 7.

TABLE I
Flexible Glass

| Elastic Modulus | 73.6 | GPa |
|---|---|---|
| Poisson's Ratio | 0.23 | |
| Density | 2380 | kg/m³ |
| CTE | 31.7 | e⁻⁷ 1/° C. |

TABLE II

| Dimension | Value | | Description |
|---|---|---|---|
| Ds | 20″ | | Supply roller diameter |
| D1 | 5″ | | 1^{st} screener roller diameter |
| D2 | 5″ | | 2^{nd} screener roller diameter |
| Dd | 20″ | | Drive roller diameter |
| L | 10′ | | Distance between the supply and the drive rollers |
| X1 | 4′1″ | | 1^{st} screener roller coordinate |
| X2 | 5′1″ | | 2^{nd} screener roller coordinate |
| dY1 | 2.5″ | | 1^{st} screener roller insertion |
| dY2 | 2.5″ | | 2^{nd} screener roller insertion |
| Ls | 1′ | | Distance between screener rollers |
| h | 200 | μm | Glass thickness |
| F | 4.5 | kg | Web force |

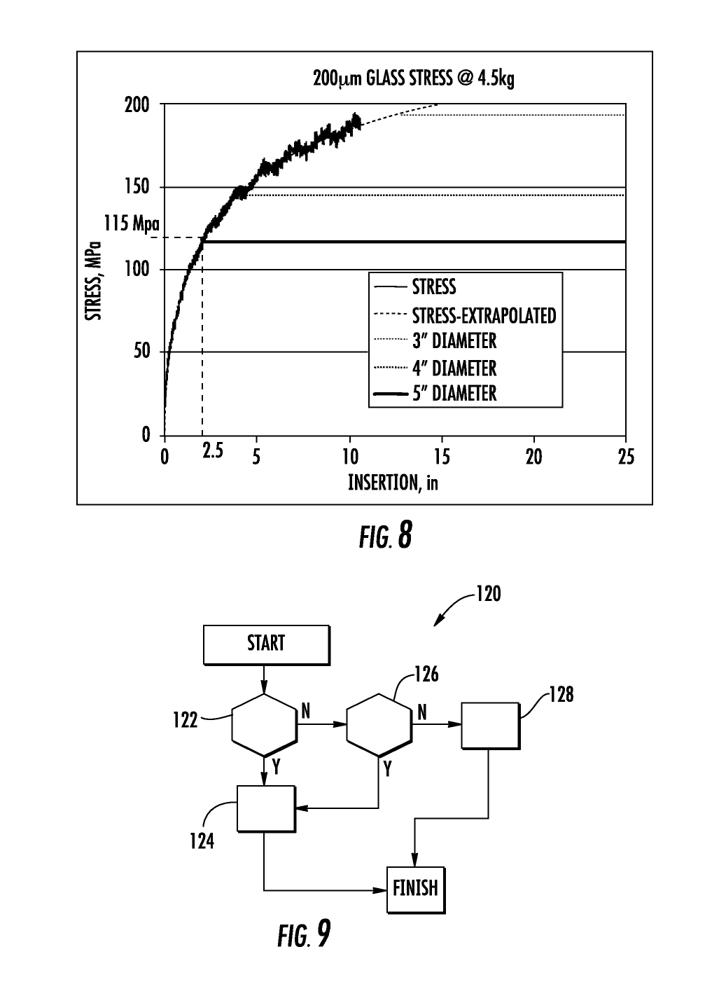

Unexpectedly, as shown by FIG. 8, the model generated about the same bending stress value of about 115 MPa at the first screener roller when using any of the 3, 4 or 5 inch roller diameters. Because the maximum allowable deflection was 2.5 inches for the rollers, the ability to generate additional bend stress was limited. For example, the maximum bend stress predicted by beam theory for a 200 μm flexible glass substrate and three-inch diameter roller was 194 MPa. In order to increase the bend stress for the flexible glass substrate, the tension capacity may be increased and/or the allowable roller deflections may be increased thereby increasing the ribbon deflection angle.

Referring to FIG. 9, a method 120 of selecting roller diameter as a function of glass thickness, ribbon tension and ribbon deflection angle is shown. The method 120 is used to determine whether a roller design guide should be used (for a single roller case) or an FEA software tool should be used (for a multiple roller case). At step 122, it is determined whether the glass processing apparatus includes a single roller or multiple rollers. If a single roller is used, then at step 124 a design guide may be used to determine a suitable roller diameter, line tension, ribbon thickness and ribbon deflection angle for a desired bend stress. If multiple rollers are used, at step 126 it is determined whether the distance between the adjacent rollers is greater than about 10 times the diameter of the roller of concern. If the distance between adjacent rollers is greater than 10 times the diameter of the roller of concern, then the design guide may be used at step 124. If the distance between adjacent rollers is less than or equal to 10 times the diameter of the roller of concern, then an FEA software tool may be used (e.g., using equations 2-5 above) at step 128.

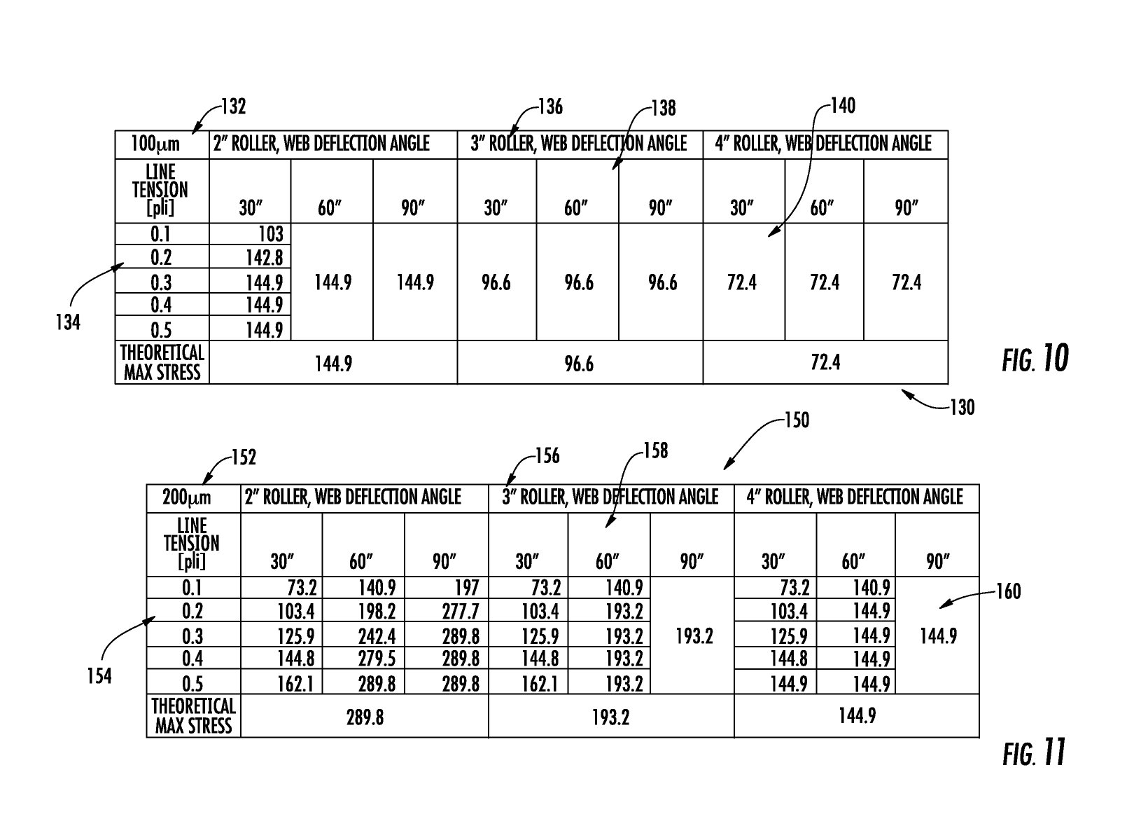

Referring to FIG. 10, an exemplary design guide 130 is illustrated in the form of a table and includes ribbon thickness information 132, line tension information 134, roller diameter information 136, ribbon deflection information 138 and bend stress information 140. The design guide 130 may be available on a printed medium or as a table saved in memory of a computer, as examples. In operation, it may be given that a 100 μm thick flexible glass ribbon is to be processed (e.g., screened, coated, cleaned, etc.). As an example, if a bend stress of at least 100 MPa is desired in the flexible glass ribbon during processing, it can be seen that the three and four-inch diameter rollers, alone, are incapable of delivering a bend stress of at least 100 MPa, at least up to a 0.5 pli line tension. However, a two-inch diameter roller may be capable of generating a bend stress of at least 100 MPa at a 30 degree web deflection angle and a 0.1 pli line tension.

Referring to FIG. 11, another exemplary design guide 150 is illustrated in the form of a table and also includes ribbon thickness information 152, line tension information 154, roller diameter information 156, ribbon deflection information 158 and bend stress information 160. As above, the design guide 150 may be available on a printed medium or as a table saved in memory of a computer, as examples. In operation, it may be given that a 200 μm thick flexible glass ribbon is to be processed (e.g., screened, coated, cleaned, etc.). As an example, if a bend stress of at least 144.9 MPa is desired in the flexible glass ribbon during processing, it can be seen that 144.9 MPa is the maximum bend stress predicted by beam theory for a four-inch roller. However, one can reduce the roller footprint by selecting a two-inch roller at a line tension of about 0.4 pli and ribbon deflection angle of about 30 degrees. It can also be observed that use of line tensions of less than 0.4 pli for a four-inch roller can result in bend stresses significantly less than the maximum bend stress of 144.9 MPa predicted by beam theory, where the ribbon deflection angle is 30 degrees or less.

The above-described systems and method utilize flexible glass ribbon stiffness to manage bending stress over rolls. Flexibility of roll-to-roll apparatus can be improved by enabling use of smaller roller diameters while meeting desired bend stress requirements and provide the ability to make roll-to-roll trade-offs without impacting reliability. The improved design information can be leveraged to minimize growth of flaws in the flexible glass ribbon during glass processing by reducing the magnitude of applied bend stress, which can preserve glass strength attributes. Removal of strength limiting flaw populations can be removed from the flexible glass ribbon more reliably, which are a function of the applied bend stress. Screening effectiveness can be improved, which can reduce potential quality costs associated with spool returns due to glass breakage. The methods described herein can enable equipment makers to design apparatus using reduced roller diameters for the reliable processing of ultra-thin glass. Current roll-to-roll systems (e.g., used to process polymers) may be more easily converted for reliable processing of flexible glass ribbon.

It should be emphasized that the above-described embodiments of the present invention, particularly any “preferred” embodiments, are merely possible examples of implementations, merely set forth for a clear understanding of various principles of the invention. Many variations and modifications may be made to the above-described embodiments of the invention without departing substantially from the spirit and various principles of the invention. All such modifications and variations are intended to be included herein within the scope of this disclosure and the following claims.

1. A method of continuously processing a flexible glass ribbon having a thickness of no more than 0.3 mm, the method comprising:
continuously feeding the flexible glass ribbon about a conveying structure having a radius of curvature that is less than a minimum radius of curvature (R) calculated using formula (1):
R=Eh/(2σ) (1)
where σ is a predetermined bend stress, E is a Young's Modulus of the flexible glass ribbon and h is the thickness of the flexible glass ribbon.

2. The method of claim 1 further comprising applying at least the predetermined bend stress to the flexible glass ribbon using the conveying structure having less than the minimum radius of curvature.

3. The method of claim 1 further comprising applying a line tension to the flexible glass ribbon suitable for applying at least the predetermined bend stress to the flexible glass ribbon using the conveying structure having less than the minimum radius of curvature.

4. The method of claim 1 further comprising applying a web deflection angle to the flexible glass ribbon suitable for applying at least the predetermined bend stress to the flexible glass ribbon using the conveying structure having less than the minimum radius of curvature.

5. The method of claim 1, wherein the conveying structure comprises a roller or an air bar.

6. A continuous glass processing apparatus for processing a flexible glass ribbon having a thickness of no more than about 0.3 mm, the apparatus comprising:
a conveying structure having a radius of curvature that is less than a minimum radius of curvature (R) calculated using formula (1):
R=Eh/(2σ) (1)
where σ is a predetermined bend stress, E is a Young's Modulus of the flexible glass ribbon and h is the thickness of the flexible glass ribbon.

7. The apparatus of claim 6, wherein the conveying structure comprises a roller or an air bar.

8. The apparatus of claim 6 further comprising;
an unwind station configured to unwind the flexible glass ribbon from a supply roll; and
a spooling station configured to wind the flexible glass ribbon onto a wind-up roll.

9. The apparatus of claim 6 further comprising a vacuum deposition station configured to apply a coating to the flexible glass ribbon.

10. The apparatus of claim 6, wherein the apparatus comprises a screener configured to produce at least the predetermined bend stress in the flexible glass ribbon.

11. A method of selecting a radius of curvature for a conveying structure of a continuous glass processing apparatus for processing a flexible glass ribbon having a thickness of no more than about 0.3 mm, the method comprising:
identifying a thickness of the flexible glass ribbon;
selecting a predetermined bending stress level suitable for the flexible glass ribbon during the processing of the flexible glass ribbon; and
selecting a radius of curvature for the conveying structure based on the predetermined bending stress level and at least one of a web deflection angle or a line tension.

12. The method of claim 11, wherein the step of selecting the radius of curvature comprises using a design guide comprising a table.

13. The method of claim 12, wherein the table comprises ribbon thickness information, line tension information, roller diameter information, web deflection information, and bend stress information.

14. The method of claim 12, wherein the table is displayed on a printed medium or saved in memory of a computer.

15. The method of claim 11 comprising selecting a radius of curvature for multiple conveying structures suitable for conveying the flexible glass ribbon during the processing of the flexible glass ribbon through the glass processing apparatus based on at least one of web deflection angle and line tension.

16. The method of claim 15, wherein the multiple conveying structures are adjacent, the method further comprising determining a distance between the adjacent conveying structures.

17. The method of claim 16, wherein if the distance between the adjacent conveying structures is less than a predetermined distance, the step of selecting the radius of curvature comprises using a design guide comprising a table.

18. The method of claim 16, wherein if the distance between the adjacent conveying structures is more than a predetermined distance, the step of selecting the radius of curvature comprises using a finite element analysis software tool.

19. The method of claim 11, wherein the conveying structure comprises a roller or an air bar.

20. The method of claim 11 comprising:
continuously feeding the flexible glass ribbon about the conveying structure at the web deflection angle and the line tension, the conveying structure having the radius of curvature selected based on the predetermined bending stress level and the at least one of the web deflection angle or the line tension.
